(19) United States
(12) Patent Application Publication
(10) Pub. No.: US 2026/0216549 A1
(43) Pub. Date: Jul. 30, 2026

(54) FIRE-FIGHTING FOAMS CONTAINING MICA

(71) Applicant: Tyco Fire Products LP, Cranston, RI (US)

(72) Inventors: Asad Imamali Karim, Cedar Park, TX (US); John P. Libal, Peshtigo, WI (US)

(73) Assignee: Tyco Fire Products LP, Cranston, RI (US)

(21) Appl. No.: 19/146,882

(22) PCT Filed: Feb. 27, 2024
(86) PCT No.: PCT/IB2024/051835

§ 371 Date: Jul. 9, 2025

Related U.S. Application Data
(60) Provisional application No. 63/487,529, filed on Feb. 28, 2023.

(51) Int. Cl. A62D 1/02

(52) U.S. Cl. CPC A62D 1/0071

(57) ABSTRACT

A fire-fighting composition includes an aqueous fire-fighting foam concentrate comprising a polysaccharide thickener and a mineral component comprising mica. An aqueous fire-fighting foam concentrate includes a sugar component; a polysaccharide thickener; a mineral component comprising mica; a surfactant component including an anionic surfactant, a zwitterionic surfactant, or a mixture of any two or more thereof; a water-miscible organic solvent; and at least about 30 wt. % water.

### CROSS REFERENCE TO RELATED APPLICATIONS

This application claims the benefit of priority to U.S. Provisional Patent Application No. 63/487,529 filed Feb. 28, 2023, which is hereby incorporated by reference, in its entirety for any and all purposes.

### BACKGROUND

Firefighting foams are often able to fight Class A and Class B fires. Class A fires are those involving combustible material such as paper, wood, etc. and can be fought by quenching and cooling with large quantities of water or solutions containing water. Class B fires are those involving flammable liquid fuels, gasoline, and other hydrocarbons and are difficult to extinguish. Most flammable liquids exhibit high vapor pressure along with low fire and flash points. This typically results in a wide flammability range. In this type of fire, the use of water as the sole firefighting agent is generally ineffective because the only means of fighting fire with water is through cooling.

Conventional foam-forming firefighting compositions commonly include Per- and Polyfluorinated Substances (PFAS) including perfluorinated surfactants. There is a strong desire in the marketplace to replace these PFAS-containing firefighting products with non-fluorinated products. There is therefore a continuing need to produce non-fluorinated firefighting compositions, also known as synthetic fluorine-free foams or SFFF that can be deployed to fight Class A and Class B fires.

Further, firefighting foams need to be usable across a wide temperature range, which means that the devices (e.g., a proportioner) used to dose the aqueous firefighting foam concentrate into an aqueous diluent need to produce approximately the same concentration of the concentrate at room temperature as they do at the minimum use temperature.

Many of the polymers required for extinguishing a fire form a gel at lower temperatures, which causes a significant increase in viscosity at lower temperatures. This increase in viscosity impedes the flow of the firefighting foam concentrate through the proportioner, which then leads to a decrease in the concentration of the concentrate that is dosed into the aqueous diluent. The performance standards for firefighting foams in the United States require that the concentration produced by a proportioner at its minimum use temperature must be at least 85% of what it produces at room temperature. Thus there is a need for firefighting foam compositions that do not form a gel at their minimum use temperature.

### SUMMARY

The present application is directed to aqueous concentrates that can be diluted with an aqueous diluent to provide a foam precursor composition, which may be aerated to form a firefighting foam.

In an aspect, the present compositions include an aqueous fire-fighting foam concentrate including a polysaccharide thickener; and a mineral component including mica.

In one aspect, an aqueous firefighting foam concentrate is provided, which comprises a sugar component; a polysaccharide thickener; a mineral component including mica; a surfactant component including an anionic surfactant, a zwitterionic surfactant, or a mixture of any two or more thereof; an organic solvent, e.g., a water-miscible organic solvent; and at least about 30 wt. % water. The aqueous firefighting foam concentrate may be substantially free of any fluorinated compounds and, often, is completely free of any fluorinated surfactant or other fluorinated compounds. In some embodiments, the amount of fluorine is below detection limits.

In some embodiments, the aqueous fire-fighting foam concentrate comprises about 5 to 40 wt. % of the sugar component; about 2 to 20 wt. % of the anionic surfactant; about 1 to 10 wt. % of the zwitterionic surfactant; about 0.1 to 5 wt. % of the polysaccharide thickener; about 0.002 to 0.008 wt. % of the mineral component; about 1 to 20 wt. % of an organic solvent; and at least about 30 wt. % water.

In some embodiments, the mica comprises muscovite, paragonite, margarite, biotite, lepidolite, phlogopite, zinnwaldite, or a mixture of any two or more thereof.

In some embodiments, the sugar component comprises a monosaccharide sugar, a disaccharide sugar, a polysaccharide sugar, a sugar alcohol, or a mixture of any two or more thereof. In some embodiments, the sugar component comprises glucose, fructose, mannose, xylose, sucrose, lactose, maltose, lactulose, trehalose, cellobiose, chitobiose, xylitol, sorbitol, mannitol, or a mixture of any two or more thereof.

In some embodiments, the anionic surfactant comprises an alkyl sulfate salt, an alkyl sulfonate salt, an alkyl ether sulfate surfactant, an alkyl ether sulfonate surfactant, or a mixture of any two or more thereof. In some embodiments, the anionic surfactant comprises C₈-C₁₄ alkyl sulfate, C₈-C₁₄ alkyl sulfonate, C₁₀-C₁₄ alkyl ether sulfate, or a mixture of any two or more thereof. In some embodiments, the anionic surfactant comprises a decyl sulfate salt, a lauryl sulfate salt, or a mixture of any two or more thereof.

In some embodiments, the zwitterionic surfactant comprises an alkylamidoalkyl hydroxysultaine, an alkylamidoalkyl betaine, an alkyl sulfobetaine, an alkyl betaine, or a mixture of any two or more thereof. In some embodiments, the zwitterionic surfactant comprises an alkylamidopropyl hydroxysultaine, cocamidopropyl hydroxysultaine, laurylamidopropyl hydroxysultaine, or myristylamidopropyl hydroxysultaine.

In some embodiments, the water-miscible organic solvent comprises an alkylene glycol, a glycerol, a water-soluble polyethylene glycol, a glycol ether, or a mixture of any two or more thereof. In some embodiments, the organic solvent comprises propylene glycol and diethylene glycol monobutyl ether.

In some embodiments, the aqueous firefighting foam concentrate is free of a nonionic surfactant.

In some embodiments, the surfactant component further comprises a nonionic surfactant. In some embodiments, the nonionic surfactant comprises an alkyl polyglycoside, an aliphatic alcohol-based nonionic surfactant, or a mixture of any two or more thereof. In some embodiments, the nonionic surfactant comprises an alkyl polyglucoside, an aliphatic alcohol, an aliphatic alcohol ethoxylate, or a mixture of any two or more thereof. In some embodiments, the aqueous fire-fighting foam concentrate further comprises about 0.2 to 5 wt % of a nonionic surfactant.

In some embodiments, the polysaccharide thickener comprises agar, sodium alginate, carrageenan, gum arabic, gum guaicum, neem gum, pistacia lentiscus, gum chatti, caranna, galactomannan, gum tragacanth, karaya gum, guar gum, welan gum, rhamsam gum, locust bean gum, beta-glucan, cellulose, methylcellulose, chicle gum, kino gum, dammar gum, glucomannan, succinoglycan, mastic gum, spruce gum, tara gum, gellan gum, xanthan gum, acacia gum, cassia gum, diutan gum, fenugreek gum, ghatti gum, hydroxyethylcellulose, hydroxypropylmethylcellulose, karaya gum, konjac gum, pectin, propylene glycol alginate, or a mixture of any two or more thereof.

In some embodiments, the aqueous fire-fighting foam concentrate further comprises a reducing agent. In some embodiments, the reducing agent comprises sodium sulfite, sodium metabisulfite, sodium bisulfite, or a mixture of any two or more thereof.

In some embodiments, the aqueous fire-fighting foam concentrate contains an amount of fluorinated surfactants that is below detection limits.

In an aspect, provided is a method of forming a firefighting foam, the method including: dosing any one of the aqueous fire-fighting foam concentrates described herein into an aqueous diluent to form a foam precursor solution; and aerating the foam precursor solution to form the firefighting foam. In some embodiments, the aqueous diluent is selected from the group consisting of fresh water, brackish water, sea water, and a mixture of any two or more thereof. In some embodiments, the aqueous diluent comprises water from a municipal water source.

In some embodiments, a concentration of the aqueous fire-fighting foam concentrate dosed into the aqueous diluent at a minimum use temperature is at least about 85% of a concentration of the aqueous fire-fighting foam concentrate dosed into the aqueous diluent at room temperature. In some embodiments, the minimum use temperature is at or below 35° F.

In another aspect, a firefighting foam is provided, the firefighting foam including any one of the firefighting foam concentrates described herein and an aqueous diluent. In an aspect, a method of fighting a fire is provided, the method including applying the firefighting foam to the fire.

### BRIEF DESCRIPTION OF THE DRAWINGS

FIG. 1 shows the 35° F./65° F. induction rates of an exemplary aqueous firefighting foam concentrate having different concentrations of mica.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Firefighting foams need to be usable across a wide temperature range. Provided herein are aqueous firefighting foam concentrates including a polysaccharide thickener; and a mineral component including mica, wherein a concentration of the aqueous fire-fighting foam concentrate dosed into an aqueous diluent at a minimum use temperature is at least about 85% of a concentration of the aqueous fire-fighting foam concentrate dosed into the aqueous diluent at room temperature.

In one aspect, the aqueous firefighting foam compositions include an aqueous fire-fighting foam concentrate having a polysaccharide thickener and a mineral component that includes mica. The aqueous firefighting foam compositions may further include a sugar component; a polysaccharide thickener; a surfactant component that includes an anionic surfactant, a zwitterionic surfactant, or a mixture of any two or more thereof; a mineral component that includes mica; a water-miscible organic solvent; and at least about 30 wt. % water.

Saccharides for use in the present aqueous fire-fighting foam concentrates are generally simple monosaccharide sugars and may include other carbohydrates, such as common sugar (sucrose/dextrose) derived from sugar cane or sugar beets. Sucrose is a disaccharide composed from the basic, simple sugar molecules glucose and fructose. Mixtures where the majority of the sucrose has been broken down into its monosaccharide components, glucose and fructose (e.g., invert sugar), are suitable for use in the present concentrates. Sucrose is readily available in view of its world production from cane and sugar beet on the order of millions of tons per annum. Those skilled in the art will also be aware that other commercially available simple monosaccharides and related sugar alcohols can be utilized in the foam concentrates. Examples of suitable monosaccharides for use in the foam concentrates include one or more of glucose, fructose, mannose, xylose and galactose. Examples of suitable disaccharides for use in the foam concentrates include one or more of sucrose, lactose, maltose, trehalose, lactulose, cellobiose, and chitobiose. Examples of suitable polysaccharide sugars for use in the foam concentrates include one or more of cellulose, starch, glycogen, and chitin. Examples of suitable sugar alcohols for use in the foam concentrates include one or more of a four carbon sugar alcohol, such as erythritol, a five carbon alditol, such as xylitol, a six carbon alditol, such as mannitol and/or sorbitol, and other sugar alcohols, such as isomalt. Commonly, the sugar alcohol is one derived from a monosaccharide.

The aqueous fire-fighting foam concentrate includes a sugar component including a monosaccharide sugar, a disaccharide sugar, and/or a sugar alcohol. Suitable examples of the sugar component include one or more of glucose, fructose, mannose, sucrose, lactose, maltose, trehalose, lactulose, cellobiose, chitobiose, xylose, sorbitol, xylitol and mannitol. The aqueous fire-fighting foam concentrate includes about 5 to 40 wt % of the sugar component. In other embodiments, the aqueous fire-fighting foam concentrate includes about 10 to 30 wt % of the sugar component. In some embodiments, the aqueous fire-fighting foam concentrate comprises about 5 wt. %, about 10 wt. %, about 15 wt. %, about 20 wt. %, about 25 wt. %, about 30 wt. %, about 35 wt. %, or about 40 wt. % of the sugar component.

Illustrative anionic surfactants include an alkyl sulfate surfactant, an alkyl sulfonate surfactant, an alkyl ether sulfate surfactant, an alkyl ether sulfonate surfactant, or a mixture of any two or more thereof. In some embodiments, the anionic surfactant may include an alkyl sulfate surfactant and/or an alkyl sulfonate surfactant. In some embodiments, the alkyl sulfate salt surfactant includes a C₈₋₁₂-alkyl sulfate salt. Non-limiting examples of the C₈₋₁₂-alkyl sulfate salt include a dodecyl sulfate salt, a decyl sulfate salt, an octyl sulfate salt, or a mixture of any two or more thereof. In some embodiments, the alkyl sulfate salt includes an alkyl sulfate sodium salt, such as a sodium decyl sulfate, sodium octyl sulfate, or a mixture of any two or more thereof. In some embodiments, the alkyl sulfate salt includes an alkyl sulfate ammonium salt, such as an ammonium decyl sulfate, ammonium octyl sulfate, ammonium lauryl sulfate, or a mixture of any two or more thereof. In some embodiments, the anionic surfactant includes a C₈₋₁₄-alkyl sulfate salt and/or a C₈₋₁₄-alkyl sulfonate salt. In some embodiments, the aqueous fire-fighting foam concentrates include an anionic surfactant, which comprises one or more surfactants selected from C₈₋₁₂-alkyl sulfate salts and/or a C₈₋₁₂-alkyl sulfonate salts. As a non-limiting example, one or more of octyl sulfate salts, decyl sulfate salts, dodecyl sulfate salts and tetradecyl sulfate salts may be used as anionic surfactants in the present aqueous fire-fighting foam concentrates. The anionic surfactant may be a sodium, potassium and/or ammonium salt. In some embodiments, the aqueous fire-fighting foam concentrates include about 2 to 20 wt % of the anionic surfactant. In some embodiments, the aqueous firefighting foam concentrates include about 2 to 15 wt %, about 2 to 10 wt %, or about 3 to 10 wt % of the anionic surfactant.

Illustrative zwitterionic surfactants include an alkylamidoalkyl betaine surfactant, an alkyl betaine surfactant, an alkyl sulfobetaine surfactant, an alkylamidoalkylene hydroxysultaine surfactant, such as an alkylamidopropyl hydroxysultaine surfactant, or a mixture of two or more thereof. As a non-limiting example, the aqueous fire-fighting foam concentrates include a zwitterionic surfactant, which comprises one or more of a C₈₋₁₈-alkylamidopropyl hydroxysultaine surfactant, a C₈₋₁₈-alkylamidopropyl betaine surfactant, a C₈₋₁₈-alkyl sulfobetaine surfactant, a C₈₋₁₈-alkyl betaine surfactant, or a mixture of two or more thereof. Non-limiting examples of the alkylamidoalkylene hydroxysultaine surfactant include a C₈₋₁₈-alkylamidopropyl hydroxysultaine surfactant, such as a cocamidopropyl hydroxysultaine surfactant, which includes a laurylamidopropyl hydroxysultaine and a myristylamidopropyl hydroxysultaine. Non-limiting examples of the alkylamidoalkyl betaine surfactant include a C₈₋₁₈-alkylamidoalkyl betaine surfactant, such as a cocamidopropyl betaine, a tallowamidopropyl betaine, a laurylamidopropyl betaine or a myristylamidopropyl betaine. In some embodiments, the zwitterionic surfactant includes a C₈₋₁₄-alkylamidopropyl hydroxysultaine, such as a cocamidopropyl hydroxysultaine. In some embodiments, the zwitterionic surfactant includes laurylamidopropyl hydroxysultaine and/or myristylamidopropyl hydroxysultaine. In some embodiments, the aqueous fire-fighting foam concentrates include about 1 to 10 wt. % of the zwitterionic surfactant. In some embodiments, the aqueous fire-fighting foam concentrates include about 2 to 10 wt. %, about 5 to 10 wt. %, or about 1 to 5 wt. % of the zwitterionic surfactant.

When present in the aqueous fire-fighting foam concentrate, non-ionic surfactants include an alkyl polyglycoside, an aliphatic alcohol-based nonionic surfactant, or a mixture of any two or more thereof. In some embodiments, the non-ionic surfactant comprises an alkyl polyglucoside, an aliphatic alcohol, an aliphatic alcohol ethoxylate, or a mixture of two or more thereof. A suitable alkyl polyglucoside for use as a non-ionic surfactant includes a C₈₋₁₆ alkyl polyglucoside. In some embodiments, the alkyl polyglucoside is a C₈-alkyl polyglucoside. As a non-limiting example, the aqueous firefighting foam concentrate may include an aliphatic alcohol-based nonionic surfactant including an aliphatic alcohol having 8 to 14 carbon atoms and/or an aliphatic alcohol ethoxylate having 10 to 16 carbon atoms in its alcohol portion. The aliphatic alcohol ethoxylate may has an average degree of polymerization (i.e., the average number of ethylene oxide units) of about 0.7-2.0 and often of no more than about 1.5, no more than about 1.2, or no more than about 1.0. Aliphatic alcohols, which include a linear C₈₋₁₄-aliphatic alcohol, such as a C₈₋₁₄-fatty alcohol, may be used as a nonionic surfactant in the present firefighting concentrates. Non-limiting examples of such alcohols include one or more of octyl alcohol, decyl alcohol, lauryl alcohol and myristyl alcohol. The aqueous firefighting foam concentrate may include an aliphatic alcohol ethoxylate having an average of no more than about 2 ethylene oxide units. In some embodiments, the aliphatic alcohol portion of such ethoxylates has about 10 to 16 carbon atoms. Non-limiting examples include decyl alcohol ethoxylates, lauryl alcohol ethoxylates and/or myristyl alcohol ethoxylates. In some embodiments, the alcohol ethoxylates have an average of no more than about 2 ethylene oxide units, no more than about 1.5 ethylene oxide units, no more than about 1.2 ethylene oxide units and, in some instances, no more than about 1 ethylene oxide units. In some embodiments, the aliphatic alcohol ethoxylate comprises an ethoxylate of a linear C₈₋₁₄-aliphatic alcohol having no more than about 1.2 ethylene oxide units.

In embodiments that include the nonionic surfactant, the aqueous fire-fighting foam concentrate includes about 1 to 15 wt %, about 1 to 10 wt %, about 3 to 10 wt %, or about 5 to 10 wt % of the non-ionic surfactant. In some embodiments, the aqueous fire-fighting foam concentrates include about 1 wt %, about 3 wt %, about 5 wt %, about 10 wt %, or about 15 wt % of the non-ionic surfactant.

In some embodiments, the aqueous fire-fighting foam concentrate is free of a non-ionic surfactant.

The present aqueous fire-fighting foam concentrates include a mineral component such as mica. Mica is a mineral that is insoluble in water and forms small platelike particles though basal cleavage when ground. Without wishing to be bound by any theory or mechanism, when incorporated into an aqueous firefighting foam concentrate that gels at low temperatures, these platelike particles interrupt the gel structure effectively reducing its yield stress which is the amount of energy that must be applied to a gel before it begins to flow. Suitable examples of mica include muscovite, paragonite, margarite, biotite, lepidolite, phlogopite, flurophlogopites, zinnwaldite, or a mixture of any two or more thereof. The aqueous fire-fighting foam concentrate may include about 0.002 to about 0.008 wt. %, about 0.002 to about 0.006 wt. %, about 0.002 to about 0.004 wt. %, about 0.004 to about 0.008 wt. %, or about 0.006 to about 0.008 wt. % of the mineral component.

The water miscible organic solvent may suitably include one or more of a glycol, a glycol ether, glycerin (i.e., glycerol) and a water-soluble polyethylene glycol. Examples of suitable water miscible organic solvents include diethylene glycol n-butyl ether, dipropylene glycol n-propyl ether, hexylene glycol, ethylene glycol, propylene glycol, diethylene glycol, dipropylene glycol, tripropylene glycol, dipropylene glycol monobutyl ether, dipropylene glycol monomethyl ether, diethylene glycol monobutyl ether, ethylene glycol monobutyl ether, tripropylene glycol monomethyl ether, dipropylene glycol monoethyl ether, glycerol, and mixtures of two or more thereof. In some embodiments, the water miscible organic solvent includes a mixture of an alkylene glycol and a glycol ether, such as a glycol butyl ether. In some embodiments, the water miscible organic solvent includes an alkylene glycol ether, such as ethylene glycol monoalkyl ether, propylene glycol monoalkyl ether, dipropylene glycol monoalkyl ether, and/or diethylene glycol monoalkyl ether. In some embodiments, the water miscible organic solvent includes an alkylene glycol, such as ethylene glycol, propylene glycol, dipropylene glycol and/or diethylene glycol. In some embodiments, the water miscible organic solvent may include a mixture of a glycol ether, such as diethylene glycol monobutyl ether, and a glycol, such as ethylene glycol and/or propylene glycol. For example, the water miscible organic solvent can include ethylene glycol and diethylene glycol monobutyl ether. In another suitable example, the water miscible organic solvent includes propylene glycol and diethylene glycol monobutyl ether.

The aqueous fire-fighting foam concentrates may include about 1 to about 20 wt. % of the water miscible organic solvent. This may include from about 1 to about 20 wt. %, about 1 to about 15 wt. %, or about 1 to about 10 wt. % of the water miscible organic solvent. In many embodiments, the aqueous firefighting foam concentrate includes a water miscible organic solvent including one or more of an alkylene glycol, glycerol, and a glycol ether. The alkylene glycol typically includes propylene glycol and/or ethylene glycol. The glycol ether typically includes ethylene glycol monoalkyl ether, diethylene glycol monoalkyl ether, dipropylene glycol monoalkyl ether, triethylene glycol monoalkyl ether, and 1-butoxyethoxy-2-propanol. In some embodiments, the water miscible organic solvent may be a mixture of an alkylene glycol and a glycol ether. In some embodiments, the water miscible organic solvent may be a mixture of glycerin and a glycol ether. In some embodiments, the water miscible organic solvent may be a mixture of propylene glycol and a glycol ether. In such embodiments, the water miscible organic solvent includes the alkylene glycol and glycol ether in a weight ratio of about 0.1:1 to about 10:1 or about 0.2:1 to about 5:1. In some embodiments, the water miscible organic solvent may be a mixture of glycerin and diethylene glycol monobutyl ether. In some embodiments, the water miscible organic solvent may include about 1 to about 20 wt. % or about 1 to about 15 wt. % of alkylene glycol, such as ethylene glycol, or glycerin together with about 1 to about 15 wt. % or about 1 to about 10 wt. % of a glycol ether, such as diethylene glycol monobutyl ether.

The aqueous firefighting foam composition includes a thickener, such as a polysaccharide thickener. The polysaccharide thickener may include a polysaccharide that is soluble in the aqueous firefighting foam concentrate and a second polysaccharide that is less soluble or insoluble in the aqueous firefighting foam concentrate. In some embodiments, the second polysaccharide may be at least partially insoluble (and dispersed) in the aqueous firefighting concentrate, but may be soluble in water alone or in solutions where the concentrate has been diluted with a much larger volume of water. In other embodiments, the concentrate may only include one or more polysaccharides that are completely soluble in the concentrate. The aqueous firefighting foam concentrate typically includes about 0.1 to about 5 wt. % of the polysaccharide thickener. In some embodiments, the aqueous firefighting foam concentrate includes about 0.2 to about 3 wt. %, about 0.5 to about 3 wt. % and, more commonly, about 0.5 to about 2 wt. % of the polysaccharide thickener.

Examples of suitable polysaccharide thickeners which may be used in the present aqueous firefighting foam concentrates include agar, sodium alginate, carrageenan, gum arabic, gum guaicum, neem gum, pistacia lentiscus, gum chatti, caranna, galactomannan, gum tragacanth, karaya gum, guar gum, welan gum, rhamsam gum, locust bean gum, beta-glucan, cellulose, methylcellulose, chicle gum, kino gum, dammar gum, glucomannan, succinoglycan, mastic gum, spruce gum, tara gum, gellan gum, acacia gum, cassia gum, diutan gum, fenugreek gum, ghatti gum, hydroxyethylcellulose, hydroxypropylmethylcellulose, karaya gum, konjac gum, pectin, propylene glycol alginate, and a mixture of two or more thereof.

In some embodiments, the polysaccharide thickener may include one or more of xanthan gum, diutan gum, rhamsan gum, welan gum, gellan gum, guar gum, konjac gum, tara gum, succinoglycan, and methylcellulose. In some embodiments, it may to include a mixture of xanthan gum and one or more of diutan gum, rhamsan gum, welan gum, gellan gum, guar gum, konjac gum, tara gum, succinoglycan, and methylcellulose. In other embodiments, the foam concentrate may include a mixture of xanthan gum and one or more of diutan gum, rhamsan gum, welan gum, succinoglycan, and gellan gum as the polysaccharide thickener. In other embodiments, the foam concentrate may include a mixture of xanthan gum and diutan gum and/or rhamsan gum. In other embodiments, the foam concentrate may include a mixture of xanthan gum and succinoglycan. In other embodiments, the foam concentrate may include a mixture of xanthan gum and welan gum. In other embodiments, the foam concentrate may include welan gum.

Polysaccharide thickeners, which include a mixture of xanthan gum and diutan gum, are suitable for use in the foam concentrates, according to various embodiments. The foam concentrate may include about 0.2 to 3 wt % of xanthan gum and about 0.1 to 2 wt % diutan gum. This may include from about 0.3 to 2 wt %, about 0.5 to 1.5 wt %, or about 0.5 to 1 wt % xanthan gum, and about 0.2 to 1.5 wt % or about 0.2 to 1 wt % diutan gum.

In other embodiments, polysaccharide thickeners that include a mixture of xanthan gum and welan gum are suitable for use in the foam concentrates. For example, the foam concentrate may include about 0.2 to 3 wt % of xanthan gum and about 0.1 to 5 wt % welan gum. This includes about 0.3 to 2 wt %, about 0.5 to 1.5 wt %, or about 0.5 to 1 wt % xanthan gum, and about 0.2 to 4 wt % or about 0.5 to 3 wt % welan gum.

In other embodiments, polysaccharide thickeners that include a mixture of xanthan gum and succinoglycan are suitable for use in the foam concentrates. For example, the foam concentrate may include about 0.2 to 3 wt % of xanthan gum and about 0.1 to 5 wt % of succinoglycan. This includes about 0.3 to 2 wt %, about 0.5 to 1.5 wt %, or about 0.5 to 1 wt % of xanthan gum, and about 0.2 to 4 wt % or about 0.5 to 3 wt % of succinoglycan.

As discussed above, the aqueous firefighting foam concentrate includes water. In some embodiments, the water is water from a municipal water source (e.g., tap water). In some embodiments, the water is a purified water, such as purified water that meets the standards set forth in the United States Pharmacopeia, which is incorporated by reference herein in relevant part. In some embodiments, the aqueous firefighting foam composition includes at least about 30 wt. % water, often at least about 40 wt. % water and, more commonly, at least about 50 wt. % water. In some embodiments, the aqueous firefighting foam concentrate includes greater than about 60 wt. % water. In some embodiments, the aqueous firefighting foam composition may be produced using a source of water that has a total concentration of fluorine atoms on a weight percentage basis of no more than about 1 ppm F. In further embodiments, the aqueous firefighting foam composition may be produced using a source of water that has an amount of fluorine that is below detection limits.

The present aqueous firefighting foam concentrates may be substantially free of any fluorinated compounds. As used herein, the “phrase substantially free of fluorinated compounds” means that the aqueous firefighting foam concentrate includes no more than 0.1 wt % fluorinated compounds. In some embodiments, the aqueous firefighting foam concentrate includes no more than 0.01 wt % and, in some instances, no more than about 0.005 wt % fluorinated compounds. The aqueous firefighting foam concentrate may be substantially free of fluorine in any form. As used herein, the phrase “substantially free of fluorine” means that the aqueous firefighting foam concentrate has a total concentration of fluorine atoms on a weight percentage basis of no more than about 1 ppm F. In some embodiments, the aqueous firefighting foam concentrate has a total concentration of fluorine atoms of less than 0.01 wt. %. In some embodiments, the aqueous firefighting foam concentrate has a total concentration of fluorine atoms of less than 0.005 wt. %. In some embodiments, the aqueous firefighting foam concentrate has a total concentration of fluorine atoms on a weight percentage basis of no more than about 70 parts per trillion (ppt) F. The aqueous firefighting foam concentrate may include substantially less than 70 ppt F. In some embodiments, the total concentration of fluorine in the aqueous firefighting foam concentrate is below detection limits.

In any of the above embodiments, the aqueous firefighting foam concentrate includes one or more chelators or sequestering buffers. Illustrative and non-limiting chelators and sequestering buffers include agents that sequester and chelate metal ions, including polyamminopolycarboxylic acids, ethylenediaminetetraacetic acid, citric acid, tartaric acid, nitrilotriacetic acid, hydroxyethylethylenediaminetriacetic acid and salts thereof. Illustrative buffers include Sorensen's phosphate or Mellvaine's citrate buffers.

In any of the above embodiments, the aqueous firefighting foam concentrate includes one or more corrosion inhibitors. Illustrative and non-limiting corrosion inhibitors includes ortho-phenylphenol, tolyltriazole, and phosphate ester acids. In some embodiments, the corrosion inhibitor is tolyltriazole.

In any of the above embodiments, the aqueous firefighting foam concentrate may also include a metallic salt, typically a metallic salt, which includes a multi-valent cation. For example, suitable salts may include a cation selected from the group consisting of aluminum, calcium, copper, iron, magnesium, potassium, and calcium cations. The counter anion may suitably be a sulfate, bicarbonate, and/or phosphate anion. In one embodiment, the metallic salt may include magnesium sulfate. In some embodiments, the metallic salt includes potassium bicarbonate.

In any of the above embodiments, the aqueous firefighting foam concentration may include a reducing agent. Accordingly, an aqueous fire-fighting foam concentrate may include a sugar component including a monosaccharide sugar, a disaccharide sugar, a sugar alcohol, or a mixture of any two or more thereof; a polysaccharide thickener; a mineral component including mica; a surfactant component including an anionic surfactant, a zwitterionic surfactant, or a mixture of any two or more thereof; a water-miscible organic solvent; at least about 30 wt. % of water; and a reducing agent. When present, the reducing agent may be present in the foam concentration from about 0.01 wt % to about 5 wt %. This may include from about 0.01 wt % to about 3 wt %, from about 0.05 wt % to about 5 wt %, from about 1 wt % to about 5 wt %, or from about 1 wt % to about 3 wt % of the reducing agent.

The reducing agent may be selected such that it is more readily oxidized compared to other components of the foam. For example, the reducing agent may be oxidized more readily than the sugar component or polysaccharide components. Illustrative reducing agents include, but are not limited to, sodium sulfite, sodium bisulfite, sodium metabisulfite, or a mixture of any two or more thereof.

In any of the above embodiments, the aqueous firefighting foam concentrate may also include a preservative, such as one or more antimicrobial compounds and/or biocidal compounds. These components are included to prevent the biological decomposition of natural product based polymers that are incorporated as polymeric film formers (e.g., a polysaccharide gum). Examples include Kathon CG/ICP (Rohm & Haas Company), Givgard G-4 40 (Givaudan, Inc.), Dowicil 75, and Dowacide A (Dow Chemical Company).

In any of the above embodiments, the aqueous firefighting foam concentrate may further include microfibrous cellulose. The microfibrous cellulose included in the aqueous firefighting foam concentrates may include microfibrous cellulose produced by mechanically disrupting/altering cellulose fibers, e.g., cereal, wood, and/or cotton-based cellulose fibers-commonly referred to as microfibrillated cellulose (MFC). Microfibrillated cellulose can be obtained through a fibrillation process of cellulose fibers. In such a process, the mechanical shearing can strip away the outer layer of the cellulose fibers, exposing the fibril bundles. The macroscopic fibers are typically mechanically sheared until the fibrils are released, resulting in separation of the cellulose fibers into a three dimensional network of microfibrils with a very large surface area. The exposed fibrils are much smaller in diameter compared to the original fibers and can form a network or a web-like structure.

An illustrative and non-limiting example of microfibrillated cellulose is Exilva™ microfibrillated cellulose (available from Borregaard, Sarpsborg, Norway). Exilva™ microfibrillated cellulose is a pre-activated product, available as a 2% suspension or a 10% paste, that is produced from mechanically disrupting cellulose sourced from Norway spruce. Exilva™ microfibrillated cellulose is reported to be an insoluble microfibrillated cellulose consisting of an entanglement of the cellulose fibers, which has the ability to interact both physically through its extreme surface area and chemically through hydrogen bonding. Other commercial sources of microfibrous cellulose include Celova® microfibrillated cellulose (available from Weidmann Electrical Technology AG (Rapperswil, Switzerland) and Curran® microfibrillated cellulose (available from CelluComp, Fife, Scotland). Curran® microfibrillated cellulose is produced from extraction of nanocellulose fibers from waste streams of root vegetables, primarily carrots and sugar beet pulp.

Another illustrative and non-limiting example of a source of microfibrillated cellulose for use in the present aqueous firefighting foam concentrates is microfibrillated cellulose-mineral composite commercially available from FiberLean® Technologies (Par Moor Centre, United Kingdom). The FiberLean® MFC-composite is reportedly produced by fibrillating the cellulose fibers in the presence of one of a number of different minerals, such as calcium carbonate, clay (e.g., kaolin or bentonite), alumina, zirconia, graphite, silicate or talc, to obtain a nano-fibrillar cellulose suspension.

When included in the aqueous firefighting foam concentrate, the microfibrous cellulose may include a fermentation-derived cellulose, such as a microfibrous cellulose derived from a microbial fermentation process. The microfibrous cellulose may include cellulose derived from a bacterial fermentation process, e.g., from fermentation of a Komagataeibacter xylinus strain or an Acetobacter xylinum strain. Fermentation-derived cellulose (FDC) produced by such a method may have an average fiber diameter of about 0.1-0.2 μm. This very small fiber size and diameter means that a given weight of FDC can have up to 200 times more surface area than other common forms of cellulose.

The microfibrous cellulose employed in the present aqueous firefighting foam concentrates may have an average fiber diameter of no more than about 10 μm, no more than about 1 μm, and in some instances about 50 to 300 nm (0.05-0.3 μm). Quite often, the microfibrous cellulose is a derived from microbial fermentation. Prior to inclusion in the aqueous firefighting foam concentrates, such microbial fermentation derived cellulose may be activated by combining a powdered microfibrous cellulose and any optional co-agent with water and then mixing with high shear.

Any of the aqueous firefighting foam concentrates described above may also include one or more of a chelator, a buffer, a corrosion inhibitor, and a preservative. Such aqueous firefighting foam concentrates may have a pH of about 7 to 9.

Tables 1 and 2 below provide an illustration of suitable formulations of the present aqueous firefighting foam concentrates designed to be combined with an aqueous diluent, aerated, and administered to fight a fire as a firefighting foam.

TABLE 1

| Ingredient | Amount (wt. %) |
|---|---|
| Biocide | 0-1.0 |
| Corrosion Inhibitor | 0-0.1 |
| Sugar Component | 5-40 |
| Zwitterionic Surfactant | 1-10 |
| Nonionic Surfactant | 0-5 |
| Anionic Surfactant | 2-20 |
| Mineral Component | 0.002-0.008 |
| Organic Solvent | 1-20 |
| Polysaccharide Gum | 0.1-5 |
| Water | 30-85 |

TABLE 2

| Ingredient | Amount (wt. %) |
|---|---|
| Biocide | 0-1.0 |
| Corrosion Inhibitor | 0-0.1 |
| Sugar Component | 5-25 |
| Zwitterionic Surfactant | 1-5 |
| Nonionic Surfactant | 0-5 |
| Anionic Surfactant | 2-10 |
| Mineral Component | 0.002-0.008 |
| Organic Solvent | 2-10 |
| Polysaccharide Gum | 0.2-3 |
| Water | 30-85 |

### Method of Producing a Firefighting Foam

The aqueous firefighting foam concentrates described herein may be mixed with an aqueous diluent to form firefighting foam precursor solution, i.e., a use strength composition. The firefighting foam precursor solution may be aerated (e.g., using a nozzle) to produce a firefighting foam including the aqueous firefighting foam concentrate and the diluent. Illustrative aqueous diluents may include water, such as fresh water, brackish water, sea water, and mixtures of any two or more thereof. In some embodiments, the firefighting foam compositions described above may be 1 vol. %, 3 vol. %, or 5 vol. % concentrate solutions, meaning that the firefighting foam compositions are mixed with 99 vol. %, 97 vol. %, or 95 vol. % aqueous diluent, respectively, to form the firefighting foam precursor solution. In an embodiment, a concentration of the aqueous fire-fighting foam concentrate dosed into the aqueous diluent at a minimum use temperature (e.g., at or below 35° F.) is at least about 85% of a concentration of the aqueous fire-fighting foam concentrate dosed into the aqueous diluent at room temperature. In some embodiments, the minimum use temperature is at or below 35° F.

In some instances, it has been found that the order of addition of ingredients with appropriate agitation may impact the actual firefighting performance as seen in the UL and EN fire tests. It may be suitable to begin by mixing the sugar component with a substantial amount of water and subsequently preparing a solution or slurry of the polysaccharide thickener in the aqueous sugar solution prior to blending in the remaining components of the foam concentrate. It was found that first preparing an aqueous sugar solution by combining and mixing the sugars (e.g., glucose, fructose, sucrose, and/or sorbitol) with water may facilitate later dissolution and/or dispersal of the biogums/biopolymers (e.g., xanthan gum). This can allow the gums to properly hydrate without encapsulating (clumping) upon the addition of the surfactant(s), other optional compounds, and remaining amounts of water. Surfactants and other optional additives can then be added and the resulting mixture may finally be diluted further with water to decrease the viscosity of the preparation, if desired.

Aqueous firefighting foam concentrates that were prepared not following this order of component addition may result in polysaccharide bio gums that are encapsulated, but not fully hydrated, which can result in the production of foams that are not satisfactory for fire testing. Thus, in some embodiments, the initial formation of an aqueous sugar solution is important in process order and can be used to dissolve/disperse polysaccharide thickener(s) into the foam concentrate before addition of any other ingredients, such as surfactant(s) and/or other additives.

### Method of Fighting a Fire

The firefighting foam compositions described herein may be used to fight a fire and/or to suppress flammable vapors by mixing the aqueous firefighting foam concentrates with a diluent, aerating the resulting firefighting foam precursor solution to form a firefighting foam, and applying or administering the firefighting foam to a fire or applying the firefighting foam to the surface of a volatile flammable liquid (e.g., gasoline or other flammable hydrocarbon or a flammable polar solvent).

The present invention, thus generally described, will be understood more readily by reference to the following examples, which are provided by way of illustration and are not intended to be limiting of the present invention.

### EXAMPLES

The following examples more specifically illustrate formulations for preparing aqueous firefighting compositions according to various embodiments described above. These examples should in no way be construed as limiting the scope of the present technology.

### Example 1

Tables 3-6 below show the composition of a number of illustrative formulations of the present aqueous firefighting foam composition. The amounts shown in these tables represent the weight percentage of the particular component based on the total weight of the composition. The formulations include a) a surfactant mixture including an anionic surfactant, a zwitterionic surfactant, and/or a nonionic surfactant, b) a siloxane-based surfactant, c) organic solvent including one or more of an alkylene glycol, glycerol and a glycol ether, d) at least about 60 wt. % water; e) a polysaccharide thickener; and f) a mineral component including mica.

TABLE 3

| Ingredient | Amount (wt. %) |
|---|---|
| Biocide | 0-0.2 |
| Corrosion inhibitor | 0-0.1 |
| Water | 30-80 |
| Zwitterionic surfactant | 1-15 |
| C₈₋₁₄-Fatty alcohol | 0-5 |
| C₈₋₁₄-Alkyl sulfate surfactant | 2-15 |
| Mineral Component | 0.002-0.008 |
| Polysaccharide gum | 0.5-5 |
| Alkylene glycol | 1-15 |
| Glycol ether | 1-15 |
| Total Organic Solvent | 1-20 |
| Monosaccharide sugar(s) | 5-25 |

TABLE 4

| Ingredient | Amount (wt. %) |
|---|---|
| Biocide | 0-0.2 |
| Corrosion Inhibitor | 0-0.1 |
| Water | 50-80 |
| Alkylamidoalkyl hydroxysultaine | 1-6 |
| C₈₋₁₂-Fatty Alcohol | 0-3 |
| C₈₋₁₂-Alkylsulfate | 3-10 |
| Mineral Component | 0.002-0.008 |
| Diutan Gum | 0.1-3 |
| Xanthan Gum | 0.2-2 |
| Alkylene glycol | 1-10 |
| Glycol ether | 1-10 |
| Monosaccharide sugar(s) | 5-25 |

TABLE 5

| Ingredient | Amount (wt. %) |
|---|---|
| Biocide | 0-0.2 |
| Corrosion Inhibitor | 0-0.1 |
| Water | 50-80 |
| Alkylamidoalkyl hydroxysultaine | 1-7 |
| C₈₋₁₂-Fatty Alcohol | 0-3 |
| C₈₋₁₂-Alkylsulfate | 3-10 |
| Mineral Component | 0.002-0.008 |
| Welan Gum | 0.1-4 |
| Xanthan Gum | 0.2-2 |
| Alkylene glycol | 1-10 |
| Glycol ether | 1-10 |
| Monosaccharide sugar(s) | 5-25 |

TABLE 6

| Ingredient | Amount (wt. %) |
|---|---|
| Biocide | 0-0.2 |
| Corrosion Inhibitor | 0-0.1 |
| Water | 50-80 |
| Alkylamidoalkyl hydroxysultaine | 1-7 |
| C₈₋₁₂-Fatty Alcohol | 0-3 |
| C₈₋₁₂-Alkylsulfate | 3-10 |
| Mineral Component | 0.002-0.008 |
| Succinoglycan | 0.1-4 |
| Xanthan Gum | 0.2-2 |
| Alkylene glycol | 1-10 |
| Glycol ether | 1-10 |
| Monosaccharide sugar(s) | 5-25 |

The illustrative aqueous firefighting foam formulations shown in Tables 1-6 typically have a pH of about 7 to 9. The formulations shown in Tables 1-6 may have a pH of about 7.5 to 8.5. If necessary, a pH-adjusting agent may be added to the composition to achieve the desired pH range.

The illustrative aqueous firefighting foam formulations shown in Tables 1-6 may have a viscosity of about 1,000 to 5,000 cps and, in some embodiments, may have a viscosity of about 1,000 to 2,500 cps (as determined at room temperature (75° F./24° C.) with a #4 spindle at 30 rpm).

### Example 2

Table 7 shows an illustrative composition for an aqueous firefighting foam that includes a reducing agent. The amounts shown in these tables represent the weight percentage of the particular component based on the total weight of the composition. The formulations include a) a sugar component, b) a surfactant mixture including an anionic surfactant, a zwitterionic surfactant, and optionally a nonionic surfactant, c) a water-miscible organic solvent including one or more of an alkylene glycol, glycerol and a glycol ether, d) a mineral component including mica, f) at least about 30 wt. % water; g) a polysaccharide thickener; and h) a reducing agent.

TABLE 7

| Ingredient | Amount (wt. %) |
|---|---|
| Biocide | 0-0.2 |
| Corrosion inhibitor | 0-0.1 |
| Water | 30-80 |
| Zwitterionic surfactant | 1-15 |
| C₈₋₁₄-Fatty alcohol | 0-5 |
| C₈₋₁₄-Alkyl sulfate surfactant | 2-15 |
| Mineral Component | 0.002-0.008 |
| Polysaccharide gum | 0.5-5 |
| Alkylene glycol | 1-15 |
| Glycol ether | 1-15 |
| Total Organic Solvent | 1-20 |
| Sugar component | 5-25 |
| Reducing agent | 0.01-5 |

### Example 3

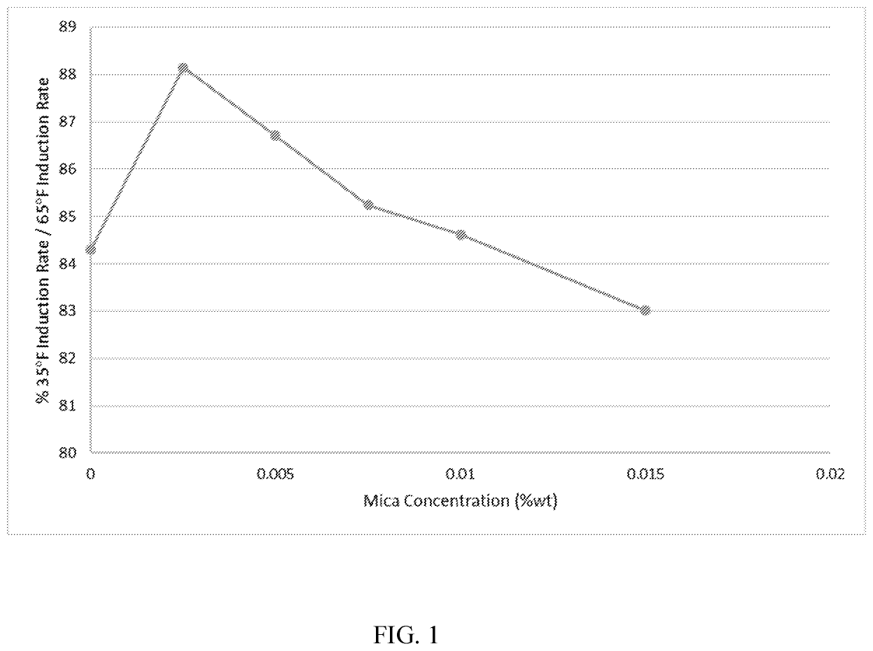

Table 8 and FIG. 1 show the 35° F./65° F. induction rate of an exemplary aqueous firefighting foam concentrate formulation having various levels of a commercially available mica added to it. The aqueous firefighting foam concentrate formulation has at least about 85% 35° F./65° F. induction rate.

TABLE 8

| % | 35° F. Induction | 65° F. Induction | % 35° F. Induction Rate/ |
|---|---|---|---|
| Mica | Rate | Rate | 65° F. Induction Rate |
| 0 | 2.9 | 3.44 | 84.3 |
| 0.0025 | 2.9 | 3.29 | 88.1 |
| 0.005 | 2.87 | 3.31 | 86.7 |
| 0.0075 | 2.83 | 3.32 | 85.2 |
| 0.01 | 2.64 | 3.12 | 84.6 |
| 0.015 | 2.59 | 3.12 | 83.0 |

While certain embodiments have been illustrated and described, it should be understood that changes and modifications can be made therein in accordance with ordinary skill in the art without departing from the technology in its broader aspects.

The embodiments illustratively described herein may suitably be practiced in the absence of any element or elements, limitation or limitations, not specifically disclosed herein. Thus, for example, the terms “comprising,” “including,” “containing,” shall be read expansively and without limitation. Additionally, the terms and expressions employed herein have been used as terms of description and not of limitation, and there is no intention in the use of such terms and expression of excluding any equivalents of the features shown and described or potions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

Additionally, where features or aspects of the disclosure are described in terms of Markush groups, those skilled in the art will realize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof.

1. A composition comprising:
an aqueous fire-fighting foam concentrate comprising a polysaccharide thickener; and
a mineral component comprising mica.

2. An aqueous fire-fighting foam concentrate comprising:
a sugar component;
a polysaccharide thickener;
a mineral component comprising mica;
a surfactant component comprising an anionic surfactant, a zwitterionic surfactant, or a mixture of any two or more thereof;
a water-miscible organic solvent; and
at least about 30 wt. % water.

3. The aqueous fire-fighting foam concentrate of claim 2 comprising:
about 5 to 40 wt. % of the sugar component;
about 2 to 20 wt. % of the anionic surfactant;
about 1 to 10 wt. % of the zwitterionic surfactant;
about 0.1 to 5 wt. % of the polysaccharide thickener;
about 0.002 to 0.008 wt. % of the mineral component;
about 1 to 20 wt. % of the water-miscible organic solvent; and
at least about 30 wt. % water.

4. The aqueous fire-fighting foam concentrate of claim 1, wherein the mica comprises muscovite, paragonite, margarite, biotite, lepidolite, phlogopite, zinnwaldite, or a mixture of any two or more thereof.

5. The aqueous fire-fighting foam concentrate of claim 2, wherein the sugar component comprises a monosaccharide sugar, a disaccharide sugar, a polysaccharide sugar, a sugar alcohol, or a mixture of any two or more thereof.

6. The aqueous fire-fighting foam concentrate of claim 2, wherein the sugar component comprises glucose, fructose, mannose, xylose, sucrose, lactose, maltose, lactulose, trehalose, cellobiose, chitobiose, xylitol, sorbitol, mannitol, or a mixture of any two or more thereof.

7. The aqueous fire-fighting foam concentrate of claim 2, wherein the anionic surfactant comprises an alkyl sulfate salt, an alkyl sulfonate salt, an alkyl ether sulfate surfactant, an alkyl ether sulfonate surfactant, or a mixture of any two or more thereof.

8. The aqueous fire-fighting foam concentrate of claim 2, wherein the anionic surfactant comprises C₈-C₁₄ alkyl sulfate, C₈-C₁₄ alkyl sulfonate, C₁₀-C₁₄ alkyl ether sulfate, or a mixture of any two or more thereof.

9. The aqueous fire-fighting foam concentrate of claim 2, wherein the anionic surfactant comprises a decyl sulfate salt, a lauryl sulfate salt, or a mixture of any two or more thereof.

10. The aqueous fire-fighting foam concentrate of claim 2, wherein the zwitterionic surfactant comprises an alkylamidoalkyl hydroxysultaine, an alkylamidoalkyl betaine, an alkyl sulfobetaine, an alkyl betaine, or a mixture of any two or more thereof.

11. The aqueous fire-fighting foam concentrate of claim 2, wherein the zwitterionic surfactant comprises an alkylamidopropyl hydroxysultaine, cocamidopropyl hydroxysultaine, laurylamidopropyl hydroxysultaine, or myristylamidopropyl hydroxysultaine.

12. The aqueous fire-fighting foam concentrate of claim 2, wherein the water-miscible organic solvent comprises an alkylene glycol, a glycerol, a water-soluble polyethylene glycol, a glycol ether, or a mixture of any two or more thereof.

13. The aqueous fire-fighting foam concentrate of claim 2, wherein the organic solvent comprises propylene glycol and diethylene glycol monobutyl ether.

14. The aqueous fire-fighting foam concentrate of claim 2, wherein the surfactant component further comprises a nonionic surfactant.

15. The aqueous fire-fighting foam concentrate of claim 14, wherein the nonionic surfactant comprises an alkyl polyglycoside, an aliphatic alcohol-based nonionic surfactant, or a mixture of any two or more thereof.

16. The aqueous fire-fighting foam concentrate of claim 14, wherein the nonionic surfactant comprises an alkyl polyglucoside, an aliphatic alcohol, an aliphatic alcohol ethoxylate, or a mixture of any two or more thereof.

17. The aqueous fire-fighting foam concentrate of claim 14, further comprising about 0.2 to 5 wt % of a nonionic surfactant.

18. The aqueous fire-fighting foam concentrate of claim 1, wherein the polysaccharide thickener comprises agar, sodium alginate, carrageenan, gum arabic, gum guaicum, neem gum, pistacia lentiscus, gum chatti, caranna, galactomannan, gum tragacanth, karaya gum, guar gum, welan gum, rhamsam gum, locust bean gum, beta-glucan, cellulose, methylcellulose, chicle gum, kino gum, dammar gum, glucomannan, succinoglycan, mastic gum, spruce gum, tara gum, gellan gum, xanthan gum, acacia gum, cassia gum, diutan gum, fenugreek gum, ghatti gum, hydroxyethylcellulose, hydroxypropylmethylcellulose, karaya gum, konjac gum, pectin, propylene glycol alginate, or a mixture of any two or more thereof.

19. The aqueous fire-fighting foam concentrate of claim 1 further comprising a reducing agent.

20-21. (canceled)

22. A method of forming a firefighting foam, the method comprising:
dosing the aqueous fire-fighting foam concentrate of claim 1 into an aqueous diluent to form a foam precursor solution; and
aerating the foam precursor solution to form the firefighting foam.

23-27. (canceled)
